(19) United States
(12) Patent Application Publication
(10) Pub. No.: US 2024/0328293 A1
(43) Pub. Date: Oct. 3, 2024

(54) Well Completion for Unconventional Subsurface Reservoirs

(71) Applicant: Saudi Arabian Oil Company, Dhahran (SA)

(72) Inventors: Sahyun Hong, Dhahran (SA); Ahmed Fataierge, Dhahran (SA); Abdulkarim Zahrani, Dhahran (SA)

(21) Appl. No.: 18/130,323

(22) Filed: Apr. 3, 2023

(51) Int. Cl. E21B 43/26; E21B 49/00

(52) U.S. Cl. CPC E21B 43/26; E21B 49/008; E21B 2200/20; E21B 2200/22

(57) ABSTRACT

Example computer-implemented methods, media, and systems for determining well production trend using subsurface condition data, well completion data, and well production data are disclosed. One example computer-implemented method includes obtaining first data associated with multiple wells, where the first data includes input data and well production data, and the input data includes subsurface condition data and well completion data. A first transformation decorrelates the input data into the second data. Multiple random numbers are generated using the second data. A second transformation correlates the multiple random numbers into imputed data of the input data, where the second transformation includes an inverse transformation of the first transformation. A predictive model between the well production data and the input data is applied to the imputed data of the input data to generate imputed data of the well production data and to predict well production trend of the multiple wells.

### TECHNICAL FIELD

The present disclosure relates to computer-implemented methods, media, and systems for well completion for unconventional subsurface reservoirs.

### BACKGROUND

Well completion for resource development from unconventional subsurface reservoirs includes the process of stimulating subsurface reservoir rocks to produce resources from the unconventional subsurface reservoirs. Customizing well completion designs per surface or subsurface conditions can be used in unconventional resource development. Examples of well completion design parameters include lateral well length, amount of injected proppant and frack water, and number of fracture clusters. Due to the local variability of petrophysical properties, single well completion design may not effectively stimulate the unconventional reservoir rocks across the field that includes the unconventional subsurface reservoirs. Determining well completion designs based on a specific geologic condition may be challenging because there can be a large number of combinations of completion designs and subsurface conditions.

### SUMMARY

The present disclosure involves computer-implemented methods, media, and systems for well completion for unconventional subsurface reservoirs using multivariate imputed data. One example computer-implemented method includes obtaining first data associated with multiple wells, where the first data includes input data and well production data, and the input data includes subsurface condition data and well completion data. A predictive model between the well production data and the input data is generated. The input data is decorrelated into second data by application of a first transformation to the input data to generate the second data. Multiple random numbers are generated using the second data. The multiple random numbers are correlated by application of a second transformation to the multiple random numbers to generate imputed data of the input data, where the second transformation includes an inverse transformation of the first transformation. The predictive model is applied to the imputed data of the input data to generate imputed data of the well production data. Well production trend of the multiple wells is predicted using the imputed data of the well production data.

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 illustrates an example workflow 100 of determining well production trend using subsurface condition data, well completion data, and well production data from multiple wells.

FIG. 2A illustrates an example of distribution of original input multivariate data in parameter space.

FIG. 2B illustrates an example of limiting the original input multivariate data.

FIG. 2C illustrates an example of estimated ultimate recovery (EUR) as a function of proppant amount based on the original input multivariate data points at the intersection of the two transparent planes in FIG. 2B.

FIG. 3A illustrates an example of preserving the multivariate relation of the original input multivariate data using the imputed data.

FIG. 3B illustrates an example of EUR as a function of proppant amount based on both the original input multivariate data and the imputed data that preserves the multivariate relation of the original input multivariate data.

FIG. 4 illustrates an example of a heatmap showing the effects of well completion parameters on well production trend.

FIG. 5 illustrates an implementation of workflow 100 of determining well production trend using subsurface condition data, well completion data, and well production data from multiple wells.

FIG. 6 illustrates an example process of determining well production trend using subsurface condition data, well completion data, and well production data from multiple wells.

FIG. 7 is a schematic illustration of example computer systems that can be used to execute implementations of the present disclosure.

Like reference numbers and designations in the various drawings indicate like elements.

### DETAILED DESCRIPTION

This disclosure relates to well completion for unconventional subsurface reservoirs using multivariate imputed data. A statistical data modeling technique can be used to predict and visualize the well performance trend against various well completion designs given the conditions of the subsurface and/or surface conditions before drilling. It can help determine completion designs, pressure drawdown strategy, and well spacing/stacking strategy without the potentially time-consuming reservoir simulation before drilling and stimulating. Multivariate data can be integrated from subsurface, completion and production variables.

In some implementations, imputed data can be generated to fill up the gap in the original multivariate data for well completion and subsurface condition variables, so that production trends against various completion designs at different given surface and/or subsurface conditions can be determined. Preserving production trends within of the given data range can be achieved by preserving multivariate relation in the original data while imputing data.

In some implementations, data imputing can be a statistical technique for estimating the missing data using the correlation within the original multivariate data. Real field data may not be comprehensive because wells may be drilled over a certain geologic area and a certain completion design may be preferred. There can be missing data in the original multivariate data.

In some implementations, determining well completion designs per a specific subsurface condition can be formulated as a data imputing problem. A large number of imputed data, for example, tens of thousands of imputed data, can be generated to fill the gap in the given completion and subsurface variables that form the original multivariate data.

In some implementations, the imputed data for the well completion and subsurface condition variables can be plugged into a pre-built predictive model to generate the predicted well production data. Therefore, the predicted well production can be obtained given pairs of the original and imputed well completion and subsurface condition data. This can provide a visualization of the well production trend against various well completion designs at specific surface (e.g. limited lateral well length) and/or subsurface conditions, for example, 5% porosity and 10,000 psi reservoir pressure.

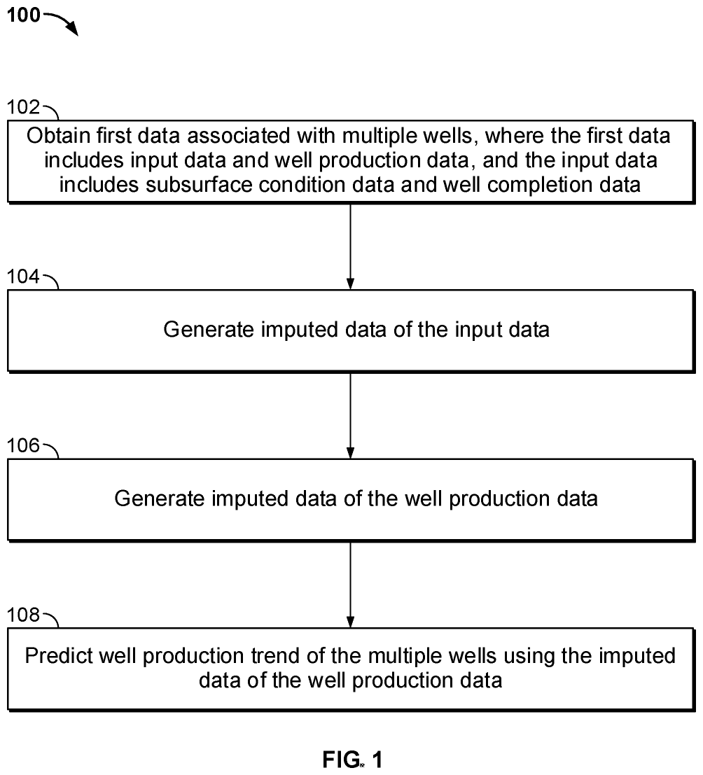

FIG. 1 illustrates an example workflow 100 of determining well production trend using subsurface condition data, well completion data, and well production data from multiple wells. Table 1 listed example variables used in the workflow.

TABLE 1
Example variables used in workflow 100

| | | |
|---|---|---|
| Target | Well production | estimated ultimate recovery (EUR) |
| variable | data | |
| Input | Subsurface data | total organic carbon (TOC), reservoir |
| variables | | pressure, porosity, volume of clay, |
| | | Young's modulus |
| | Completion data | lateral well length, total proppant |
| | | amount, total frack water volume, |
| | | number of fracture clusters |

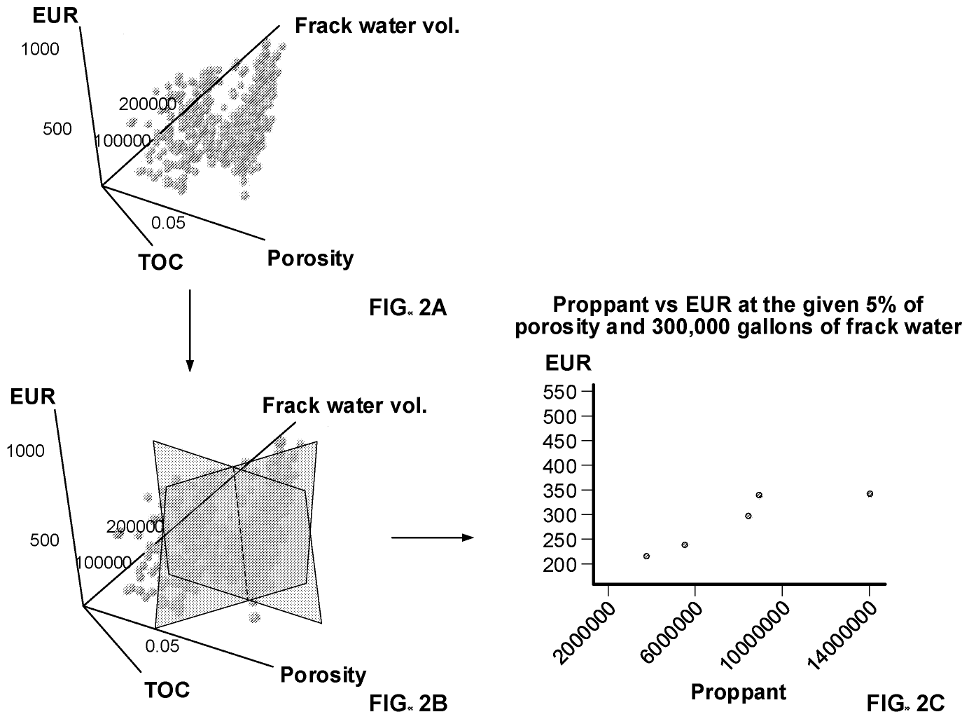

In step 102, first data associated with multiple wells is obtained, where the first data includes input data and well production data, and the input data includes subsurface condition data and well completion data. An example of the first data is the original input multivariate data shown in FIG. 2A, which illustrates an example of distribution of original input multivariate data in parameter space. Example parameters in the parameter space include three input variables that form an example of the input data, i.e., porosity and TOC for subsurface conditions and frack water volume for well completion, and one target variable EUR as an example of the well production data. FIG. 2A includes original input multivariate data from multiple wells over a field. In example 200, the original input multivariate data are from 600 wells over the US Eagle Ford basin. Table 2 describes the full names and units associated with the terms used in FIG. 2A to FIG. 4.

TABLE 2
Full names and units of terms used in FIG. 2A to FIG. 4

| Terms | Full names | Units |
|---|---|---|
| UR | Unconventional | |
| | resources | |
| EUR | Estimated ultimate | Thousand barrels of oil |
| | recovery | equivalent (MBOE) |
| TOC | Total organic carbon | Wt % |
| Por | Porosity | Decimal or % |
| Frack water | | Gallons |
| volume | | |
| Proppant | | lbs |
| Cluster | Number of fracture | Integer |
| | clusters | |
| CS | Cluster spacing | foot (lateral length/number |
| | | of fracture clusters) |
| Prop Conc | Proppant concentration | lbs/gal |
| or PPG | per gallon of frack water | |

FIG. 2B illustrates an example of limiting the original input multivariate data. The original input multivariate data in FIG. 2A is limited to a specific geographic area using specific values for frack water volume and porosity. This limitation is shown as transparent planes in FIG. 2B with a frack water volume of 300,000 gallons and an average porosity of 5%.

FIG. 2C illustrates an example of EUR as a function of proppant amount based on the original input multivariate data points at the intersection of the two transparent planes in FIG. 2B. As shown in Table 1, TOC and porosity are subsurface parameters, and proppant amount and frack water volume are well completion parameters. The data points in FIG. 2C are extracted from the data points in FIG. 2B that fall into the intersection of the two transparent planes. Because the original input multivariate data is limited in FIG. 2B by specific subsurface conditions, only five data points are shown in FIG. 2C. These five data points may not capture the trend of EUR against proppant amount. If additional limiting conditions (in addition to the frack water volume of 300,000 gallons and the average porosity of 5%) are used to further limit the original input multivariate data in FIG. 2A, for example, 7,000 ft for lateral well length due to surface constraints, then fewer or no data points would be available that can satisfy all the limiting conditions.

In some implementations, a predictive model between the well production data and the input data for modeling well production trend can be generated. The input variables of the input data can include those listed in Table 1, and well production variable of the well production data can include EUR listed as target variable in Table 1. In some implementations, the predictive model can be generated using a machine learning model or a multivariate linear regression model applied to the well production data and the input data. In one example, the generated predictive model can be used to show well production trend against total proppant amount given 300,000 gallons of frack water over the average porosity of 5%.

In step 104, imputed data of the input data is generated. In some implementations, to generate the imputed data of the input data, the input data is decorrelated into second data through the application of a first transformation to the input data to generate the second data. An example of the first transformation can include two transforms. First, apply a third transformation to the first data to transform the first data into fourth data, where the third transformation can include principal component transform. Next apply a fourth transformation to the fourth data to transform the fourth data into the second data, where the fourth transformation can include sphering transform, and the resulting second data has unit variance.

In some implementations, multiple random numbers are generated independently based on the second data. The generated random numbers can be Gaussian random numbers in some cases. The distribution of the generated random numbers can follow the distribution of the second data. In one example, the number of generated random numbers can be 50000, and the values of the random numbers can range between −3.5 to 3.5. The generated random numbers can be correlated through the application of a second transformation to the multiple random numbers to generate imputed data of the input data, where the second transformation includes an inverse transformation of the first transformation. An example of the second transformation can include two transforms. First, apply a fifth transformation to the multiple random numbers to transform the multiple random numbers into fifth data. The fifth transformation can include an inverse transformation of the fourth transformation, where the fourth transformation can include the sphering transform that was used to transform the fourth data into the second data. Next apply a sixth transformation to the fifth data to transform the fifth data into the imputed data of the input data. The sixth transformation can include an inverse transformation of the third transformation, where the third transformation can include the principal component transform that was used to transform the first data into the fourth data.

In step 106, imputed data of the well production data is generated. In some implementations, the imputed data of the well production data can be generated by applying the predictive model in step 104 to the imputed data of the input data generated in step 104.

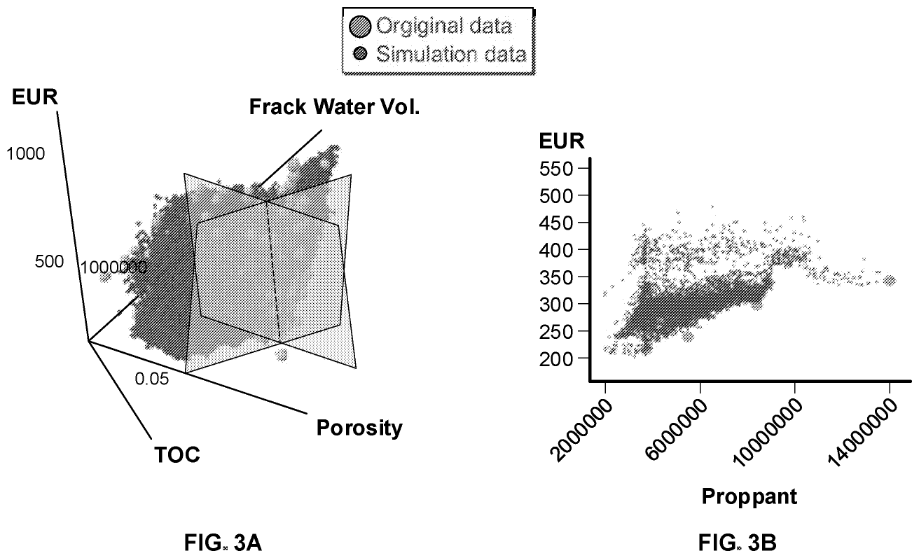

FIG. 3A illustrates an example of preserving the multivariate relation of the original input multivariate data using the imputed data. The imputed data points are represented by data points with smaller size in FIG. 3A. In some implementations, the imputed data includes the imputed data of the input data and the imputed data of the well production data, both of which can be generated using the workflow described in steps 102 to 106 of FIG. 1. An example of the number of imputed data points in FIG. 3A is 50,000. As shown in FIG. 3A, the imputed data fill up the gap of the original input multivariate data represented by data points with larger size in FIG. 3A. The imputed data can capture the multivariate relations in the original input multivariate data.

FIG. 3B illustrates an example of EUR as a function of proppant amount based on both the original input multivariate data and the imputed data that preserves the multivariate relation of the original input multivariate data. Using both the original input multivariate data points and the imputed data points in FIG. 3B, the trend of EUR against proppant amount can be determined.

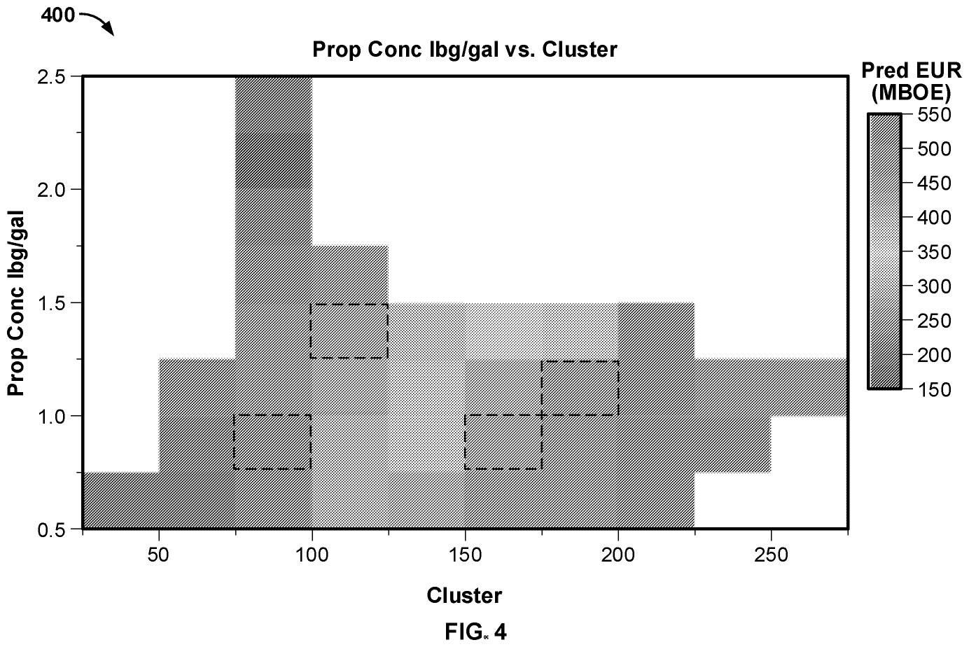

In step 108, well production trend of the multiple wells is predicted using the imputed data of the well production data. An example of the result of predicting well production trend using both the first data and the imputed data of the well production data is shown in FIG. 4, which illustrates an example 400 of a heatmap showing the effects of well completion parameters on well production trend. As shown in FIG. 4, well production trend, for example, the trend of predicted EUR, against well completion parameters, for example, the number of fracture clusters and proppant concentration per frack water volume (lbs/gallon), can be determined using both the original input multivariate data points and the imputed data points, at the fixed conditions of lateral well length of 5500 ft over the average TOC of 5%. Cells with dashed lines in FIG. 4 represent results determined using the original input multivariate data satisfying the fixed conditions. These dashed lines may not be enough to determine the trend of EUR with varying fracture cluster number and proppant concentration. On the other hand, by using the imputed data points, additional cells in FIG. 4 without dashed lines can be generated, and the trend of EUR can be determined using both the original input multivariate data points and the imputed data points.

FIG. 4 can provide visualization of how the number of fracture cluster (x-axis) and proppant concentration to frack water volume (y-axis) affects EUR. Example 400 in FIG. 4 shows that larger fracture cluster number and higher proppant concentration per frack water volume improves the well performance in terms of increased EUR. Furthermore, the rate of EUR change is different depending on the fracture cluster number and proppant concentration. Additionally, subsets of data in FIG. 4 can be used to satisfy different constraints when predicting well production trend. For example, a well production trend can be determined if a subset data corresponding to 5% of porosity, 7% of TOC, 7000 ft of lateral well length and 100-mesh proppant size is extracted from the data in FIG. 4.

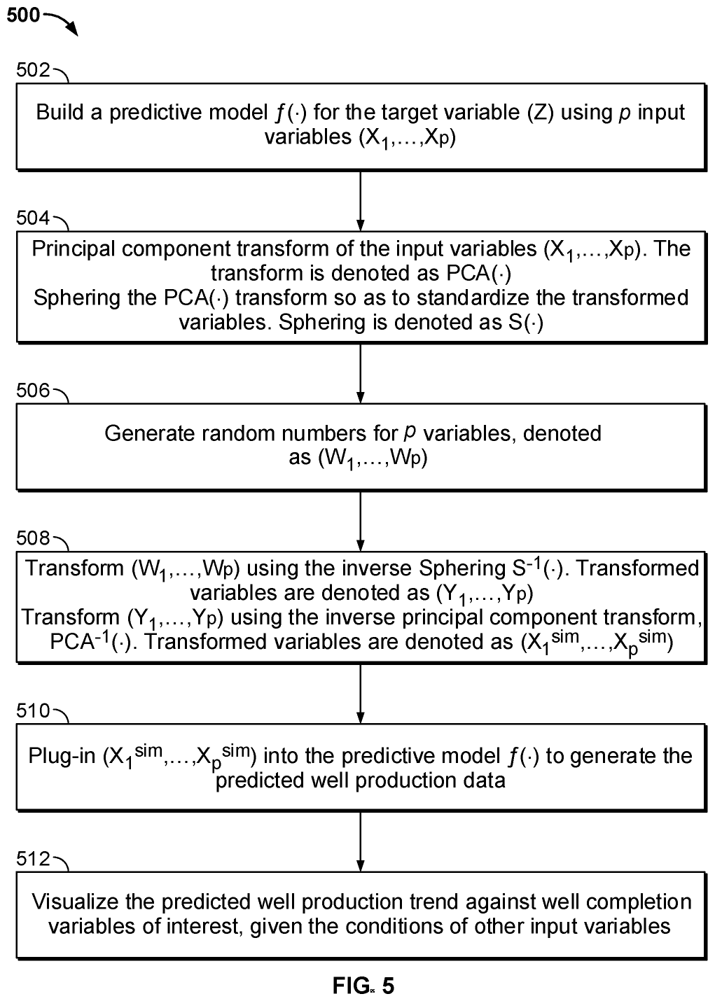

FIG. 5 illustrates an implementation 500 of workflow 100 of determining well production trend using subsurface condition data, well completion data, and well production data from multiple wells. Implementation 500 includes some implementations of steps 102 to 108 of FIG. 1 described earlier.

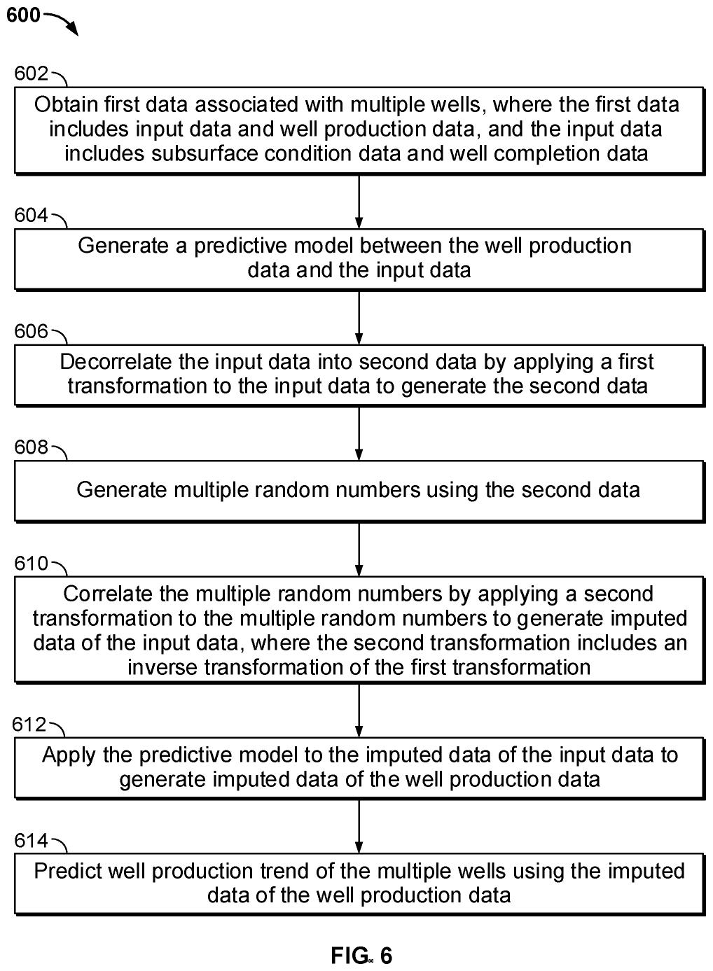

FIG. 6 illustrates an example process 600 of determining well production trend using subsurface condition data, well completion data, and well production data from multiple wells. For convenience, process 600 will be described as being performed by a system of one or more computers, located in one or more locations, and programmed appropriately in accordance with this specification.

At 602, a computer system obtains first data associated with multiple wells, where the first data includes input data and well production data, and the input data includes subsurface condition data and well completion data.

At 604, the computer system generates a predictive model between the well production data and the input data.

At 606, the computer system decorrelates the input data into second data by applying a first transformation to the input data to generate the second data.

At 608, the computer system generates multiple random numbers using the second data.

At 610, the computer system correlates the multiple random numbers by applying a second transformation to the multiple random numbers to generate imputed data of the input data, where the second transformation includes an inverse transformation of the first transformation.

At 612, the computer system applies the predictive model to the imputed data of the input data to generate imputed data of the well production data.

At 614, the computer system predicts well production trend of the multiple wells using the imputed data of the well production data.

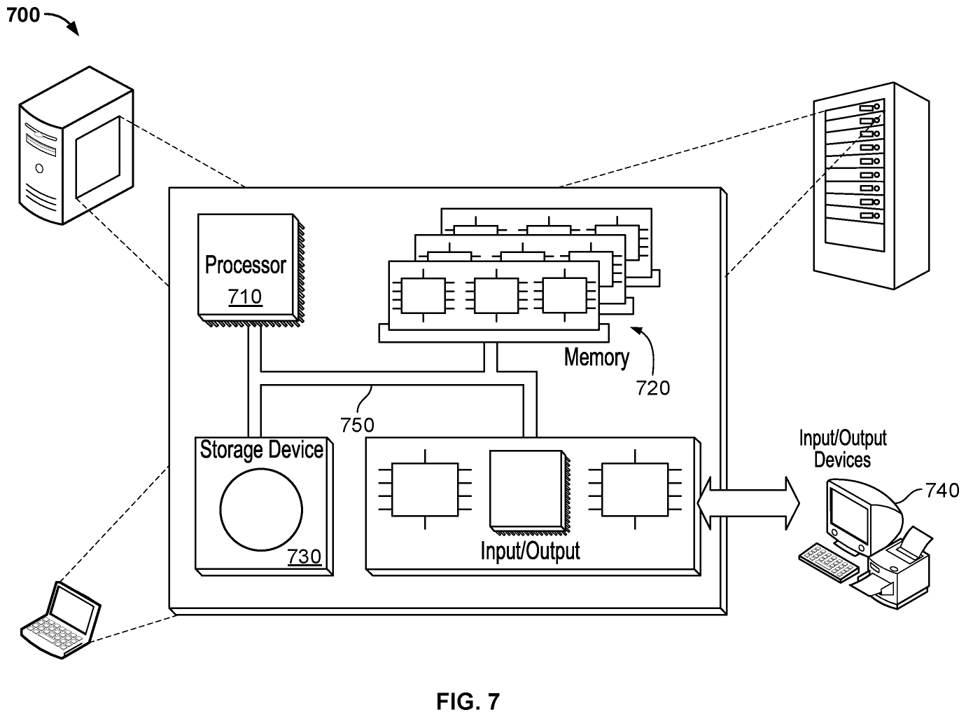

FIG. 7 illustrates a schematic diagram of an example computing system 700. The system 700 can be used for the operations described in association with the implementations described herein. For example, the system 700 may be included in any or all of the server components discussed herein. The system 700 includes a processor 710, a memory 720, a storage device 730, and an input/output device 740. The components 710, 720, 730, and 740 are interconnected using a system bus 750. The processor 710 is capable of processing instructions for execution within the system 700. In some implementations, the processor 710 is a single-threaded processor. The processor 710 is a multi-threaded processor. The processor 710 is capable of processing instructions stored in the memory 720 or on the storage device 730 to display graphical information for a user interface on the input/output device 740.

The memory 720 stores information within the system 700. In some implementations, the memory 720 is a computer-readable medium. The memory 720 is a volatile memory unit. The memory 720 is a non-volatile memory unit. The storage device 730 is capable of providing mass storage for the system 700. The storage device 730 is a computer-readable medium. The storage device 730 may be a floppy disk device, a hard disk device, an optical disk device, or a tape device. The input/output device 740 provides input/output operations for the system 700. The input/output device 740 includes a keyboard and/or pointing device. The input/output device 740 includes a display unit for displaying graphical user interfaces.

Certain aspects of the subject matter described here can be implemented as a method. First data associated with multiple wells is obtained, where the first data includes input data and well production data, and the input data includes subsurface condition data and well completion data. A predictive model between the well production data and the input data is generated. The input data is decorrelated into second data by application of a first transformation to the input data to generate the second data. Multiple random numbers are generated using the second data. The multiple random numbers are correlated by application of a second transformation to the multiple random numbers to generate imputed data of the input data, where the second transformation includes an inverse transformation of the first transformation. The predictive model is applied to the imputed data of the input data to generate imputed data of the well production data. Well production trend of the multiple wells is predicted using the imputed data of the well production data.

An aspect taken alone or combinable with any other aspect includes the following features. The subsurface condition data includes at least one of total organic carbon (TOC), reservoir pressure, porosity, volume of clay, or Young's modulus, and the subsurface condition data is from each of the multiple wells.

An aspect taken alone or combinable with any other aspect includes the following features. The well completion data includes at least one of lateral well length, total proppant amount, total frack water volume, or number of fracture clusters, and the well completion data is from each of the multiple wells.

An aspect taken alone or combinable with any other aspect includes the following features. Generating the predictive model between the well production data and the input data includes generating the predictive model using a linear regression model between the well production data and the input data.

An aspect taken alone or combinable with any other aspect includes the following features. Decorrelating the input data into the second data by applying the first transformation to the input data to generate the second data includes applying a third transformation to the input data to transform the first data into fourth data, where the third transformation includes principal component transform; and applying a fourth transformation to the fourth data to transform the fourth data into the second data, where the fourth transformation includes sphering transform.

An aspect taken alone or combinable with any other aspect includes the following features. Correlating the multiple random numbers by applying the second transformation to the multiple random numbers to generate the imputed data of the input data includes applying a fifth transformation to the multiple random numbers to transform the multiple random numbers into fifth data, where the fifth transformation includes an inverse transformation of the fourth transformation; and applying a sixth transformation to the fifth data to transform the fifth data into the imputed data of the input data, where the sixth transformation includes an inverse transformation of the third transformation.

An aspect taken alone or combinable with any other aspect includes the following features. Generating the multiple random numbers using the second data includes generating multiple Gaussian random numbers using the second data.

An aspect taken alone or combinable with any other aspect includes the following features. Predicting the well production trend of the multiple wells using the imputed data of the well production data includes predicting, based on a subset of the input data, the well production trend of the multiple wells using the imputed data of the well production data.

Certain aspects of the subject matter described in this disclosure can be implemented as a non-transitory computer-readable medium storing instructions which, when executed by a hardware-based processor perform operations including the methods described here.

Certain aspects of the subject matter described in this disclosure can be implemented as a computer-implemented system that includes one or more processors including a hardware-based processor, and a memory storage including a non-transitory computer-readable medium storing instructions which, when executed by the one or more processors performs operations including the methods described here.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A computer-implemented method, comprising:
obtaining first data associated with a plurality of wells, wherein the first data comprises input data and well production data, and wherein the input data comprises subsurface condition data and well completion data;
generating a predictive model between the well production data and the input data;
decorrelating the input data into second data by applying a first transformation to the input data to generate the second data;
generating a plurality of random numbers using the second data;
correlating the plurality of random numbers by applying a second transformation to the plurality of random numbers to generate imputed data of the input data, wherein the second transformation comprises an inverse transformation of the first transformation;
applying the predictive model to the imputed data of the input data to generate imputed data of the well production data; and
predicting well production trend of the plurality of wells using the imputed data of the well production data.

2. The computer-implemented method of claim 1, wherein the subsurface condition data comprises at least one of total organic carbon (TOC), reservoir pressure, porosity, volume of clay, or Young's modulus, and wherein the subsurface condition data is from each of the plurality of wells.

3. The computer-implemented method of claim 1, wherein the well completion data comprises at least one of lateral well length, total proppant amount, total frack water volume, or number of fracture clusters, and wherein the well completion data is from each of the plurality of wells.

4. The computer-implemented method of claim 1, wherein generating the predictive model between the well production data and the input data comprises generating the predictive model using a linear regression model between the well production data and the input data.

5. The computer-implemented method of claim 1, wherein decorrelating the input data into the second data by applying the first transformation to the input data to generate the second data comprises:
applying a third transformation to the input data to transform the first data into fourth data, wherein the third transformation comprises principal component transform; and
applying a fourth transformation to the fourth data to transform the fourth data into the second data, wherein the fourth transformation comprises sphering transform.

6. The computer-implemented method of claim 5, wherein correlating the plurality of random numbers by applying the second transformation to the plurality of random numbers to generate the imputed data of the input data comprises:
applying a fifth transformation to the plurality of random numbers to transform the plurality of random numbers into fifth data, wherein the fifth transformation comprises an inverse transformation of the fourth transformation; and
applying a sixth transformation to the fifth data to transform the fifth data into the imputed data of the input data, wherein the sixth transformation comprises an inverse transformation of the third transformation.

7. The computer-implemented method of claim 1, wherein generating the plurality of random numbers using the second data comprises generating a plurality of Gaussian random numbers using the second data.

8. The computer-implemented method of claim 1, wherein predicting the well production trend of the plurality of wells using the imputed data of the well production data comprises predicting, based on a subset of the input data, the well production trend of the plurality of wells using the imputed data of the well production data.

9. A non-transitory computer-readable medium storing one or more instructions executable by a computer system to perform operations comprising:
obtaining first data associated with a plurality of wells, wherein the first data comprises input data and well production data, and wherein the input data comprises subsurface condition data and well completion data;
generating a predictive model between the well production data and the input data;
decorrelating the input data into second data by applying a first transformation to the input data to generate the second data;
generating a plurality of random numbers using the second data;
correlating the plurality of random numbers by applying a second transformation to the plurality of random numbers to generate imputed data of the input data, wherein the second transformation comprises an inverse transformation of the first transformation;
applying the predictive model to the imputed data of the input data to generate imputed data of the well production data; and
predicting well production trend of the plurality of wells using the imputed data of the well production data.

10. The non-transitory computer-readable medium of claim 9, wherein the subsurface condition data comprises at least one of total organic carbon (TOC), reservoir pressure, porosity, volume of clay, or Young's modulus, and wherein the subsurface condition data is from each of the plurality of wells.

11. The non-transitory computer-readable medium of claim 9, wherein the well completion data comprises at least one of lateral well length, total proppant amount, total frack water volume, or number of fracture clusters, and wherein the well completion data is from each of the plurality of wells.

12. The non-transitory computer-readable medium of claim 9, wherein generating the predictive model between the well production data and the input data comprises generating the predictive model using a linear regression model between the well production data and the input data.

13. The non-transitory computer-readable medium of claim 9, wherein decorrelating the input data into the second data by applying the first transformation to the input data to generate the second data comprises:
applying a third transformation to the input data to transform the first data into fourth data, wherein the third transformation comprises principal component transform; and
applying a fourth transformation to the fourth data to transform the fourth data into the second data, wherein the fourth transformation comprises sphering transform.

14. The non-transitory computer-readable medium of claim 13, wherein correlating the plurality of random numbers by applying the second transformation to the plurality of random numbers to generate the imputed data of the input data comprises:
applying a fifth transformation to the plurality of random numbers to transform the plurality of random numbers into fifth data, wherein the fifth transformation comprises an inverse transformation of the fourth transformation; and
applying a sixth transformation to the fifth data to transform the fifth data into the imputed data of the input data, wherein the sixth transformation comprises an inverse transformation of the third transformation.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
obtaining first data associated with a plurality of wells, wherein the first data comprises input data and well production data, and wherein the input data comprises subsurface condition data and well completion data;
generating a predictive model between the well production data and the input data;
decorrelating the input data into second data by applying a first transformation to the input data to generate the second data;
generating a plurality of random numbers using the second data;
correlating the plurality of random numbers by applying a second transformation to the plurality of random numbers to generate imputed data of the input data, wherein the second transformation comprises an inverse transformation of the first transformation;
applying the predictive model to the imputed data of the input data to generate imputed data of the well production data; and
predicting well production trend of the plurality of wells using the imputed data of the well production data.

16. The computer-implemented system of claim 15, wherein the subsurface condition data comprises at least one of total organic carbon (TOC), reservoir pressure, porosity, volume of clay, or Young's modulus, and wherein the subsurface condition data is from each of the plurality of wells.

17. The computer-implemented system of claim 15, wherein the well completion data comprises at least one of lateral well length, total proppant amount, total frack water volume, or number of fracture clusters, and wherein the well completion data is from each of the plurality of wells.

18. The computer-implemented system of claim 15, wherein generating the predictive model between the well production data and the input data comprises generating the predictive model using a linear regression model between the well production data and the input data.

19. The computer-implemented system of claim 15, wherein decorrelating the input data into the second data by applying the first transformation to the input data to generate the second data comprises:
applying a third transformation to the input data to transform the first data into fourth data, wherein the third transformation comprises principal component transform; and
applying a fourth transformation to the fourth data to transform the fourth data into the second data, wherein the fourth transformation comprises sphering transform.

20. The computer-implemented system of claim 19, wherein correlating the plurality of random numbers by applying the second transformation to the plurality of random numbers to generate the imputed data of the input data comprises:
applying a fifth transformation to the plurality of random numbers to transform the plurality of random numbers into fifth data, wherein the fifth transformation comprises an inverse transformation of the fourth transformation; and
applying a sixth transformation to the fifth data to transform the fifth data into the imputed data of the input data, wherein the sixth transformation comprises an inverse transformation of the third transformation.
